(19) United States
(12) Patent Application Publication
(10) Pub. No.: US 2016/0146104 A1
(43) Pub. Date: May 26, 2016

(54) Angled Core Engine

(71) Applicant: UNITED TECHNOLOGIES CORPORATION, Hartford, CT (US)

(72) Inventors: Allan R Penda, Amston, CT (US); Jesse M. Chandler, South Windsor, CT (US); Gabriel L Suciu, Glastonbury, CT (US)

(21) Appl. No.: 14/903,609

(22) PCT Filed: Jun. 12, 2014
(86) PCT No.: PCT/US2014/042051

§ 371 Date: Jan. 8, 2016

Related U.S. Application Data
(60) Provisional application No. 61/843,475, filed on Jul. 8, 2013.

(51) Int. Cl. F02C 3/14; F04D 29/32; F01D 9/04; F01D 5/02; F02C 3/04; F01D 9/06

(52) U.S. Cl. CPC F02C 3/14; F02C 3/04; F01D 9/06; F01D 9/041; F01D 5/02; F04D 29/321; F04D 29/325; F05D 2220/32; F05D 2240/24; F05D 2240/12; F05D 2240/35

(57) ABSTRACT

A system, which may be used as a propulsion system, includes a propulsor section having a fluid operated device or free turbine, a fluid source such as a gas generator for creating an exhaust gas, and a fluid passageway for delivering the exhaust gas to the fluid operated device or free turbine. The fluid operated device may be used to drive a rotary device such as a fan.

### BACKGROUND

The present disclosure relates to an angled core engine for propelling a vehicle such as an aircraft.

A high efficiency small engine core, which includes a high pressure compressor, combustor, and a high pressure turbine, restricts the space available for low pressure rotor shafting. Recently, reverse flow core engines have been proposed. These reverse flow cores require the engine airflow to fully reverse direction twice.

### SUMMARY

In accordance with the present disclosure, there is provided a system which broadly comprises: a propulsor section having a free turbine; a gas generator for creating an exhaust gas; and a fluid passageway for delivering the exhaust gas to the free turbine.

Another embodiment may additionally and/or alternatively include, the propulsor section further has a fan driven by the free turbine.

Another embodiment may additionally and/or alternatively include, the propulsor section further includes a casing surrounding the fan and a plurality of fan exit guide vanes located within the casing.

Another embodiment may additionally and/or alternatively include, the fan and the propulsor rotate about a first axis.

Another embodiment may additionally and/or alternatively include, the gas generator has a central axis and an angle between the first axis and the central axis is less than 90 degrees.

Another embodiment may additionally and/or alternatively include, the fluid passageway comprises a plenum having an arcuately shaped conduit connected to an outlet of the gas generator and the exhaust gas flowing through the plenum turning less than 90 degrees prior to being delivered to the free turbine.

Another embodiment may additionally and/or alternatively include, the fluid passageway comprises a conduit connected to an outlet of the gas generator and having a curved section for turning the exhaust gas flow less than 90 degrees prior to being delivered to the free turbine.

Another embodiment may additionally and/or alternatively include, the system further comprises the gas generator having an inlet and an air intake communicating with the inlet to deliver ambient air to the gas generator.

Another embodiment may additionally and/or alternatively include, the system further comprises the gas generator having an inlet and the inlet ingesting air from the fan.

Another embodiment may additionally and/or alternatively include, the gas generator has a compressor section and a turbine section.

Another embodiment may additionally and/or alternatively include, the compressor section has at least one stage, and the turbine section has at least one stage.

Further in accordance with the present disclosure, there is provided a method for delivering a fluid to a fluid operated device of a gas turbine engine which broadly comprises the steps of: providing a fluid source; providing a fluid flow generating device; flowing air through the fluid flow generating device in a first direction; and delivering a fluid produced by the fluid source to a fluid operated device of the gas turbine engine by turning the fluid exiting the fluid source so that the fluid flows in the first direction.

Another embodiment may additionally and/or alternatively include, the method further comprises arranging the fluid operated device to rotate about a first axis; and orienting the fluid source so that a central axis of the fluid source is at an angle with respect to the first axis.

Another embodiment may additionally and/or alternatively include, the orienting step comprises orienting the fluid source so that the angle with respect to the first axis is less than 90 degrees.

Another embodiment may additionally and/or alternatively include, the turning of the fluid is carried out by a plenum with an arcuately shaped conduit connected to an outlet of the fluid source.

Another embodiment may additionally and/or alternatively include, the method further comprises arranging the plenum between the rotary device and the fluid operated device.

Another embodiment may additionally and/or alternatively include, the turning of the fluid is carried out by a passageway connected to an outlet of the fluid source having a curved section.

Another embodiment may additionally and/or alternatively include, the method further comprises positioning the passageway between the outlet of the fluid source and an inlet of the fluid operated device.

Another embodiment may additionally and/or alternatively include, the turning step comprises turning the fluid less than 90 degrees.

Another embodiment may additionally and/or alternatively include, the method further comprises using the fluid operated device to drive the fluid flow generating device.

Another embodiment may additionally and/or alternatively include, the step of providing a fluid source comprises providing a gas generator.

Another embodiment may additionally and/or alternatively include, the method further comprises supplying the fluid source with fluid created by the fluid flow generating device.

Other details of the angled core engine are set forth in the following detailed description and the accompanying drawings wherein like reference numerals depict like elements.

BRIEF DESCRIPTION OF THE DRAWINGS

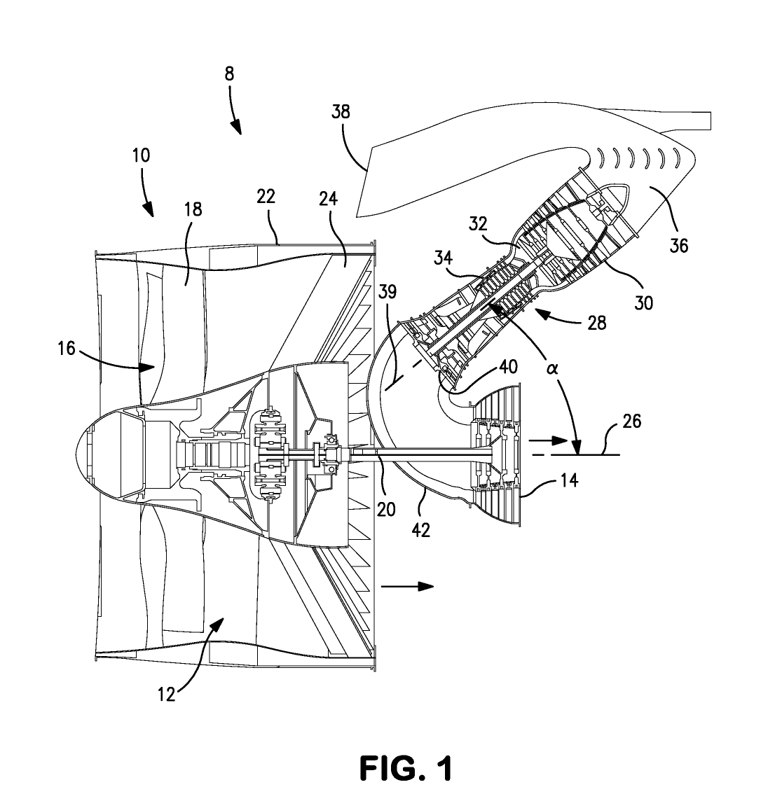

FIG. 1 is a schematic representation of a system for driving a fluid operated device; and

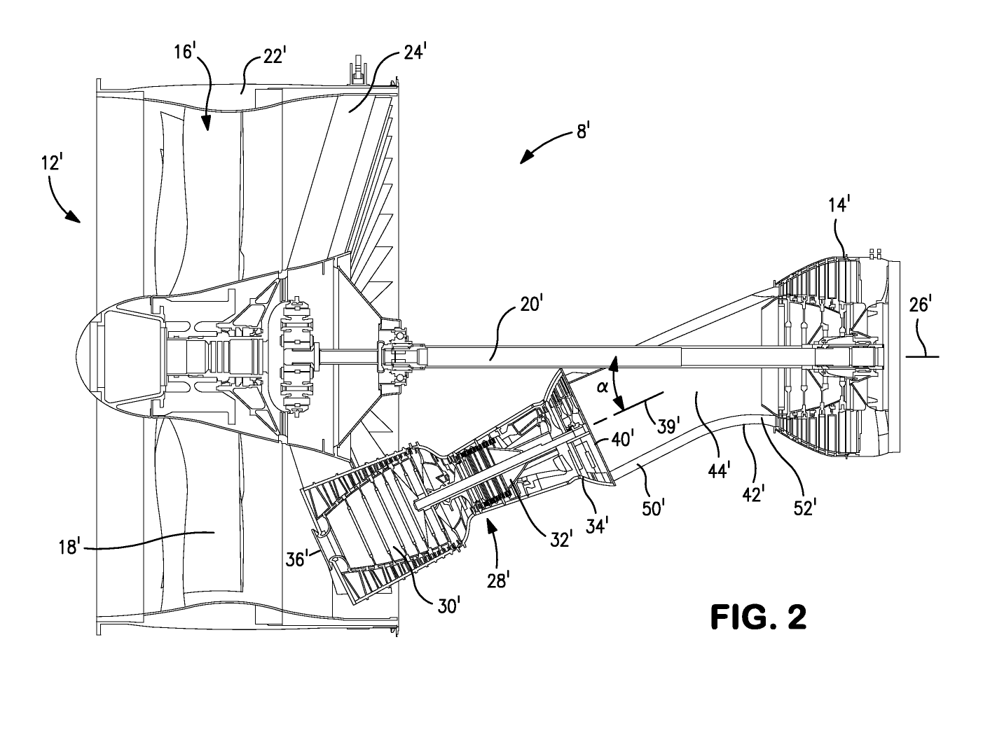

FIG. 2 is a schematic representation of another embodiment of a system for driving a fluid operated device.

### DETAILED DESCRIPTION

A system 8 for driving a fluid operated device of a gas turbine engine is shown in the FIG. 1. The system 8 may be used as a propulsion system for an aircraft in which the fluid operated device being driven is a free turbine for driving a rotary device such as a fan.

The system 8 comprises a propulsor 10 having a propulsor section 12 which includes a fluid operated device 14 such as a free turbine and a rotary device 16 such as a fan with a plurality of fan blades 18 which is driven by the fluid operated device or free turbine 14 via the shaft 20. The propulsor section 12 further includes a casing 22 surrounding the rotary device or fan 16 and a plurality of fan exit guide vanes 24 within the casing. The rotary device or fan 16 and the fluid operated device or free turbine 14 rotate about a first axis 26.

The system 8 further includes a fluid source such as a gas generator 28 for generating an exhaust fluid such as an exhaust gas. The illustrated gas generator 28 is a reverse core engine which includes a compressor section 30 having one or more stages such as a low pressure compressor and a high pressure compressor, a combustion section 32 having one or more combustors, and a turbine section 34 having one or more stages such as a low pressure turbine and a high pressure turbine. The low pressure compressor in the gas generator 28 is driven by a low pressure turbine via a low pressure spool and a high pressure compressor in the gas generator 26 is driven by a high pressure turbine via a high pressure spool. The gas generator 28 has an inlet 36 which communicates with an air intake 38. The air intake 38 receives ambient air and delivers same to the inlet 36. The gas generator 28 is arranged to have a central axis 39 which is at an angle α to the first axis 26. The angle α is less than 90 degrees.

The outlet 40 of the gas generator communicates with a plenum 42 for delivering the exhaust gas generated by the gas generator 28 to the free turbine 14. As can be seen from FIG. 1, the fluid passageway or plenum 42 may have an arcuately shaped conduit 44 which turns the exhaust gas flow exiting the gas generator 28 by an amount less than 90 degrees.

As shown in FIG. 1, the fluid passageway or plenum 42 is located between the fluid operated device or free turbine 14 and the fan exit guide vanes 24.

The exhaust gas is used to drive the fluid operated device or free turbine 14 which in turns drives the rotary device or fan 16. After passing through the fluid operated device or free turbine 14, the exhaust gas exits rearwardly along with the fluid flow created by the rotary device or fan 16. The exhaust gas exiting the free turbine 14 flows in the same direction as the fluid flow created by the rotary device or fan 16.

Referring now to FIG. 2, there is shown another system 8′ for driving a fluid operated device of a gas turbine engine. The system 8′ may be used as a propulsion system for an aircraft in which the fluid operated device being driven is a free turbine for driving a rotary device such as a fan.

The system 8′ comprises a propulsor section 12′ which includes a fluid operated device 14′ such as a free turbine and a rotary device 16′ such as a fan with a plurality of fan blades 18′ which is driven by the fluid operated device or free turbine 14′ via the shaft 20′. The propulsion section 12′ further includes a casing 22′ surrounding the rotary device or fan 16′ and a plurality of fan exit guide vanes 24′ within the casing 22′. The rotary device or fan 16′ and the fluid operated device or free turbine 14′ rotate about a first axis 26′.

The system 8′ further includes a fluid source such as gas generator 28′ for generating an exhaust fluid such as an exhaust gas. The illustrated gas generator 28′ is an engine which includes a compressor section 30′ having one or more stages such as a low pressure compressor and a high pressure compressor, a combustion section 32′ having one or more combustors, and a turbine section 34′ having one or more stages such as a low pressure turbine and a high pressure turbine. The low pressure compressor in the gas generator 28′ is driven by a low pressure turbine via a low pressure spool and a high pressure compressor in the gas generator 28′ is driven by a high pressure turbine via a high pressure spool. The gas generator 28′ has an inlet 36′ which receives air from the rotary device or fan 16′. The inlet 36′ of the gas generator 28′ may be positioned adjacent the fan exit guide vanes 24′. This allows the gas generator 28′ to be at least partially housed within the casing 22′. The gas generator 28′ is arranged to have a central axis 39′ which is at an angle α to the first axis 26′. The angle α is less than 90 degrees.

The outlet 40′ of the gas generator communicates with a fluid passageway 42′ for delivering the exhaust gas generator by the exhaust gas generator 28′ to the free turbine 14′. As can be seen from FIG. 2, the fluid passageway 42′ may be a conduit 44′ which turns the exhaust gas exiting the gas generator 28′ by an amount less than 90 degrees. The conduit 44′ has a linear section 50′ and a curved section 52′ which turns the exhaust fluid flow into the free turbine 14′.

As shown in FIG. 2, the fluid passageway 42′ is located between the fluid operated device or free turbine 14′ and the fan exit guide vanes 24′.

The exhaust gas is used to drive the fluid operated device or free turbine 14′ which in turn drives the rotary device or fan 16′. After passing through the fluid operated device or free turbine 14′, the exhaust gas exits rearwardly along with the fluid flow created by the rotary device or fan 16′. The exhaust gas exiting the free turbine 14′ flows in the same direction as the fluid flow created by the rotary device or fan 16′.

One of the advantages of the systems described hereinabove is that they eliminate the aerodynamic losses and structural issues with other types of engine designs.

There has been provided an angled core engine. While the angled core engine has been described in the context of an embodiment thereof, other unforeseen alternatives, modifications, and variations may become apparent to those skilled in the art having read the foregoing description. Accordingly, it is intended to embrace those alternatives, modifications, and variations that fall within the broad scope of the appended claims.

What is claimed is:

1. A system which comprises:
a propulsor section having a free turbine;
a gas generator for creating an exhaust gas; and
a fluid passageway for delivering said exhaust gas to said free turbine.

2. The system of claim 1, wherein said propulsor section further has a fan driven by said free turbine.

3. The system of claim 2, wherein said propulsor section further includes a casing surrounding said fan and a plurality of fan exit guide vanes located within said casing.

4. The system of claim 2, wherein said fan and said propulsor rotate about a first axis.

5. The system of claim 4, wherein said gas generator has a central axis and an angle between said first axis and said central axis is less than 90 degrees.

6. The system according to claim 1, wherein said fluid passageway comprises a plenum having an arcuately shaped conduit connected to an outlet of said gas generator and said exhaust gas flowing through said plenum turning less than 90 degrees prior to being delivered to said free turbine.

7. The system of claim 1, wherein said fluid passageway comprises a conduit connected to an outlet of said gas generator and having a curved section for turning said exhaust gas flow less than 90 degrees prior to being delivered to said free turbine.

8. The system of claim 1, further comprising said gas generator having an inlet and an air intake communicating with said inlet to deliver ambient air to said gas generator.

9. The system of claim 2, further comprising said gas generator having an inlet and said inlet ingesting air from said fan.

10. The system of claim 1, wherein said gas generator has a compressor section and a turbine section.

11. The system of claim 10, wherein said compressor section has at least one stage, and said turbine section has at least one stage.

12. A method for delivering a fluid to a fluid operated device of a gas turbine engine, said method comprising the steps of:
providing a fluid source;
providing a fluid flow generating device;
flowing air through said fluid flow generating device in a first direction; and
delivering a fluid produced by said fluid source to said fluid operated device of said gas turbine engine by turning said fluid exiting said fluid source so that said fluid flows in the first direction.

13. The method of claim 12, further comprising:
arranging said fluid operated device to rotate about a first axis; and
orienting said fluid source so that a central axis of said fluid source is at an angle with respect to said first axis.

14. The method of claim 13, wherein said orienting step comprises orienting said fluid source so that said angle with respect to said first axis is less than 90 degrees.

15. The method of claim 12, wherein said turning of said fluid is carried out by a plenum with an arcuately shaped conduit connected to an outlet of said fluid source.

16. The method of claim 15, further comprising arranging said plenum between said rotary device and said fluid operated device.

17. The method of claim 12, wherein said turning of said fluid is carried out by a passageway connected to an outlet of said fluid source having a curved section.

18. The method of claim 17, further comprising positioning said passageway between said outlet of said fluid source and an inlet of said fluid operated device.

19. The method of claim 12, wherein said turning step comprises turning said fluid less than 90 degrees.

20. The method of claim 12, further comprising using said fluid operated device to drive said fluid flow generating device.

21. The method of claim 12, wherein said step of providing a fluid source comprises providing a gas generator.

22. The method of claim 12, further comprising supplying said fluid source with fluid created by said fluid flow generating device.
